(19) United States
(12) Patent Application Publication
(10) Pub. No.: US 2014/0376167 A1
(43) Pub. Date: Dec. 25, 2014

(54) MANAGEMENT DEVICE FOR ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: ZHAO-YANG CAI, Shenzhen (CN); ZHENG-QUAN PENG, Shenzhen (CN); HAI-QING ZHOU, Shenzhen (CN); YI-XIN TU, Shenzhen (CN)

(21) Appl. No.: 14/312,872

(22) Filed: Jun. 24, 2014

(30) Foreign Application Priority Data
Jun. 24, 2013 (CN) 2013102520839

(51) Int. Cl. G06F 1/16

(52) U.S. Cl. CPC G06F 1/16
USPC 361/679.21

(57) ABSTRACT

A management device includes a control module, a display module, and an input module. The control module includes a control chip and a detecting unit. The detecting unit is used to receive first signals corresponding to a working status of hard disks and a backplane. The display module is coupled to the control chip to display parameters presenting the working status of the hard disks. The input module is used to input signals to control the display module to display more detailed parameters of the hard disks.

### FIELD

The subject matter herein generally relates to a management device for electronic devices.

### BACKGROUND

Operating parameters of devices are necessary for monitoring statuses of devices.

### BRIEF DESCRIPTION OF THE DRAWINGS

Implementations of the present technology will now be described, by way of example only, with reference to the attached FIGURE, wherein:

The FIGURE is a block diagram of an embodiment of a management device for an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a management device 10 coupled to a backplane 11.

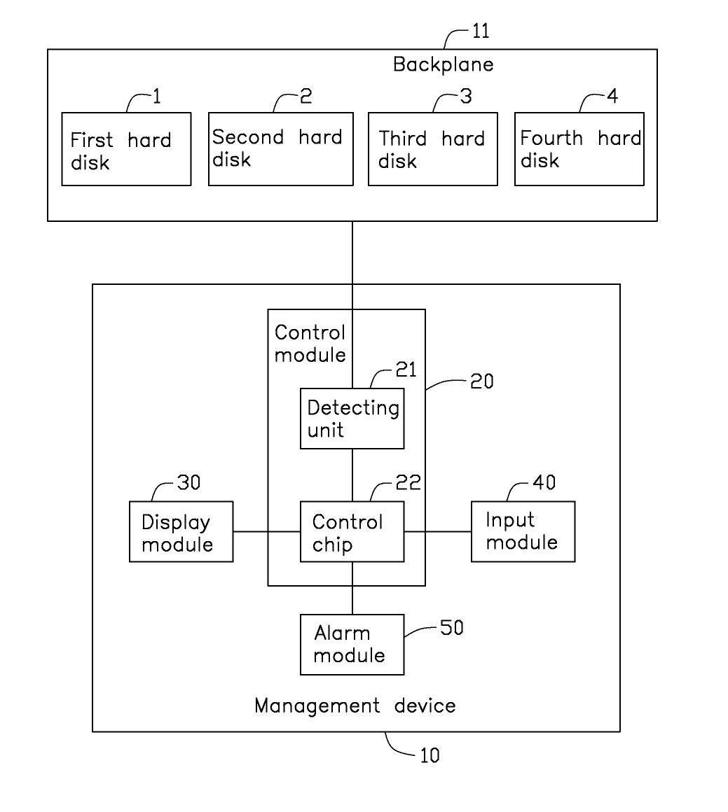

FIG. 1 illustrates an embodiment of the management device 10 and a backplane 11. The management device 10 can comprise a control module 20, a display module 30, an input module 40, and an alarm module 50. The backplane 11 can comprise a first hard disk 1, a second hard disk 2, a third hard disk 3, and a fourth hard disk 4.

The control module 20 can comprise a detecting unit 21 and a control chip 22. The detecting unit 21 can be used to receive first signals corresponding to a working status of the first through fourth hard disks 1-4 and the backplane 11. In one embodiment, the detecting unit 21 receives the first signals through a universe serial bus (not shown). In another embodiment, the detecting unit 21 can receive the first signals through an inter-integrated circuit. The control chip 22 converts the first signals into second signals, and outputs the second signals to the display module 30.

The display module 30 displays parameters corresponding to the second signals. The parameters present the working status of the first through fourth hard disks 1-4 and the backplane 11.

The input module 40 is used to input third signals to the control module 20. In one embodiment, the third signals can be input to the control module 20 to control the display module 30 to show more detailed parameters. The input module 40 can comprise a plurality of buttons.

The management device 10 can further comprise an alarm module 50. The alarm module 50 alarms when the control chip 22 determines that the working status of any of the first through fourth hard disks 1-4 and the backplane 11 are abnormal.

The embodiment shown and described above is only an example. Many details are often found in the art such as the other features of a management device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A management device coupled to a backplane which has a plurality of hard disks, the management device comprising:
a control module comprising a detecting unit and a control chip, wherein the detecting unit is coupled to the backplane to receives first signals of working status of the plurality of the hard disks and the backplane, the control chip converts the first signals into second signals;
a display module coupled to the control chip to receive the second signals, wherein the display module displays parameters presenting the working status of the plurality of the hard disks and the backplane; and
an input module coupled to the control chip to input third signals to the control module.

2. The management device of claim 1, wherein the input module comprises a plurality of buttons.

3. The management device of claim 1, wherein the third signals are input to the control module to control the display module to show detail parameters.

4. The management device of claim 1, further comprising an alarm module, wherein the alarm module alarms when the control chip determines the working status of the plurality of the hard disks and the backplane are abnormal.

5. A management device coupled to a backplane having a plurality of hard disks, the management device comprising:
a control module comprising a detecting unit and a control chip, the detecting unit coupled to the backplane and configured to receive at least one first signal indicating a working status of the plurality of hard disks and the backplane, the control chip configured to convert a first signal into at least one second signal;
a display module coupled to the control chip and configured to receive the second signal, and display parameters corresponding to the working status of the plurality of hard disks and the backplane; and
an input module coupled to the control chip and configured to input at least one third signal to the control module.
